(19) United States
(12) Patent Application Publication
(10) Pub. No.: US 2026/0082438 A1
(43) Pub. Date: Mar. 19, 2026

(54) METHODS OF CONTROLLING AN OPERATION OF A WIRELESS INTERFACE

(71) Applicants: Continental Automotive Technologies GmbH, Hannover (DE); NANYANG TECHNOLOGICAL UNIVERSITY, Singapore (SG)

(72) Inventors: David GONZÁLEZ GONZÁLEZ, Hannover (DE); Rakshith JAGANNATH, Singapore (SG); Yong Liang GUAN, Singapore (SG); Rikin SHAH, Hannover (DE)

(73) Assignees: Continental Automotive Technologies GmbH, Hannover (DE); NANYANG TECHNOLOGICAL UNIVERSITY, Singapore (SG)

(21) Appl. No.: 19/110,569

(22) PCT Filed: Sep. 27, 2023
(86) PCT No.: PCT/IB2023/059591

§ 371 Date: Mar. 11, 2025

(30) Foreign Application Priority Data
Sep. 27, 2022 (SG) 10202251182K

(51) Int. Cl. H04W 76/14; H04W 72/20

(52) U.S. Cl. CPC H04W 76/14; H04W 72/20

(57) ABSTRACT

Methods enabling reductions in the power consumption and a momentary required computational power in situations in which wireless apparatus operating in accordance with different, mutually not interoperable standards use a shared radio resource through the use of dual-mode UEs configured for executing at least some of the methods are presented. Such use of a shared radio resource may include so-called sidelink communication. In these situations the dual-mode UEs internally share information about use of resource elements in the shared resource as reserved or intended for use by UEs operating in accordance with the first communication standard, and forward such information to UEs that are limited to communicating in accordance with the second communication standard, for accordingly modifying the operation of the second-type wireless interfaces.

### CROSS REFERENCE TO RELATED APPLICATIONS

This application is the U.S. National Phase Application of PCT International Application No. PCT/IB2023/059591, filed Sep. 27, 2023, which claims priority to Singapore Patent Application No. 10202251182K, filed Sep. 27, 2022, the contents of such applications being incorporated by reference herein.

### FIELD OF THE INVENTION

The present invention relates to wireless communication, more specifically to methods of controlling an operation of a wireless interface.

### BACKGROUND

In today's connected world many devices are connected to other devices or systems through wireless connections. Such devices may include portable or mobile devices, sensors, and even motor vehicles. Several communication standards have been developed, deployed, and retired, in the past, all of which use a respective portion of the wireless spectrum for transmitting. Some older wireless communication standards include GSM (global system for mobile communication), also referred to as 2G, and UMTS (universal mobile telecommunication system), also referred to as 3G. While not fully retired, their data rates and capability to simultaneously serve a large number of users do not live up to the requirements of the ever increasing number of connected mobile devices, which led to the development and deployment of LTE (long term evolution), or 4G, and later NR (new radio), also referred to as 5G.

One important use case for both LTE and NR communication systems is found in intelligent transportation systems (ITS), which increasingly implement vehicle-to-vehicle (V2V), vehicle-to-infrastructure (V2I) and other communication between vehicles and radio-enabled objects or services in relative proximity of the vehicle. The acronym V2X, for vehicle-to-everything (or anything, for that matter) is meant to cover all conceivable communication scenarios.

In V2X communication the data transfer is preferably done directly between the communication partners, without using a base station or other elements of the network as intermediary, since direct communication exhibits lower delay between transmission and reception. As such direct communication may use the same communication interface as the LTE or NR communication that goes to and trough the corresponding network, but the data is not routed to the base station and through the network, the direct communication is also referred to as ‘sidelink’ communication, or SL.

LTE V2X is expected to operate on the 5.9 GHz band reserved in certain markets, e.g., United States, Europe, China, for ITS services. For SL communications, vehicles, wireless apparatus, or user equipment (UE), as used interchangeably herein, utilize the so-called PC5 interface, whereas they utilize the Uu interface for vehicle-to-network (V2N) communication. LTE V2X has been designed to support basic cooperative active traffic safety, traffic management, and telematics applications and services. LTE V2X supports similar services as those supported by DSRC or its European counterpart ITS-G5. These applications and services rely on the broadcast transmission of small awareness messages such as cooperative awareness messages (CAM) in ITS-G5 or basic safety messages (BSM) in DSRC to regularly provide basic information such as the location, direction, speed, and acceleration of the transmitting vehicle. LTE V2X defines new physical (PHY) and medium access control (MAC) layers for V2X and reuses the upper V2X layers and protocols specified by ETSI (European Telecommunications Standardization Institute), IEEE (Institute of Electrical and Electronic Engineers), and SAE (Society of Automotive Engineers).

LTE V2X defines two resource allocation modes, mode 3 and mode 4, for V2X SL communications. In mode 3, the cellular or network infrastructure (eNB) manages the V2X SL communications. This includes selecting and configuring the communication resources, i.e., sub-channels. In contrast, mode 4 can operate without cellular infrastructure support. In this case, vehicles autonomously select, manage and configure the sub-channels. Vehicles utilizing mode 3 need to be under network coverage, while vehicles using mode 4 can operate without network coverage.

LTE V2X uses SC-FDMA (Single-Carrier Frequency-Division Multiple Access) and supports 10 MHz and 20 MHz channels. The channel is divided into 180 KHz Resource Blocks (RBs) that correspond to 12 subcarriers of 15 kHz each. In the time domain, the channel is organized into 1 ms subframes. FIG. 1 illustrates the channelization in LTE V2X mode 4 sensing-based SPS scheduling with an exemplary length T=100 ms. Each subframe has 14 OFDM symbols with normal cyclic prefix. Nine of these symbols are used to transmit data and four of them (3rd, 6th, 9th, and 12th) are used to transmit demodulation reference signals (DMRSs) for channel estimation and combating the Doppler effect at high speeds. The last symbol is used as a guard symbol for timing adjustments and for allowing vehicles to switch between transmission and reception across subframes.

RBs are grouped into sub-channels. A sub-channel can include RBs only within the same subframe. The number of RBs per sub-channel can vary and is (pre-)configured. (Pre-)configuration refers to a configuration that is:
1) defined by the network and signalled to the UE by the cellular base station (eNB in LTE or gNB in 5G NR) when a UE is in network coverage; or
2) predefined in the UE when the UE is out of network coverage. Sub-channels are used to transmit data and control information. The data is organized in Transport Blocks (TBs)

The LTE standard does not specify an algorithm for the selection of sub-channels in mode 3. Instead, it defines two scheduling approaches, dynamic scheduling and Semi-Persistent Scheduling (SPS). With dynamic scheduling, UEs must request sub-channels from the eNB for each TB. With SPS scheduling, the eNB reserves sub-channels so that a UE can transmit several TBs. The eNB can configure the periodicity of the reserved sub-channels. LTE mode 3 can outperform LTE mode 4 since the scheduling of transmissions is centralized at the eNB. However, it requires operating in network coverage and introduces cellular uplink (UL) and downlink (DL) signalling overhead. LTE mode 3 can also encounter challenges at the cell boundaries, in particular when different operators serve neighbouring UEs.

Under LTE mode 4, UEs autonomously select their sub-channels using the sensing-based SPS scheduling scheme specified in 3GPP Release 14/15. A UE uses the selected sub-channels for the transmission of its following Reselection Counter consecutive TBs. The UE announces the reservation of the selected sub-channels for the transmission of the next TB using the Resource Reservation Interval (RRI) included in the sidelink control information (SCI). This is likewise illustrated in FIG. 1, where a UE selects sub-channel(s) at subframe t_{TX}, and informs neighbouring UEs that it reserves them for its following transmission at subframe t_{TX}+RRI. This is done to prevent other UEs from utilizing the same sub-channels at the same time. The RRI can be equal to 0 ms, 20 ms, 50 ms, 100 ms or any multiple of 100 ms up to a maximum value of 1000 ms. A UE sets the RRI equal to 0 ms to announce neighbouring UEs that it is not reserving the same sub-channels for the next TB. A UE can only select RRIs values higher than 0 ms from a (pre-)configured list of permitted RRI values. This list can contain up to 16 values although currently 3GPP standards only define 12 possible RRIs values higher than 0 ms for mode 4.

5G NR V2X has been designed to complement LTE V2X. While LTE V2X supports basic active safety and traffic management use cases, 5G NR V2X supports advanced use cases and higher automation levels. Like LTE, the 5G system architecture supports two operation modes for V2X communication, namely V2X communication over the PC5 reference point or interface and V2X communication over the Uu reference point or interface.

5G NR is specified for operation in two frequency ranges, FR1 extending from 450 MHz to 6 GHz and FR2 extending from 24.25 GHz to 52.6 GHz. In NR Uu, the maximum carrier bandwidth is 200 MHz for FR1 and 400 MHz in FR2. Although the NR infrastructure (gNB) can support such wide bandwidths, this may not be the case for all UEs, in particular low-end UEs. Furthermore, supporting a very large bandwidth may also imply higher power consumption at the UE, both from the radio frequency (RF) and baseband signal processing perspectives. To support UEs that cannot handle large bandwidths, e.g., due to processing limitations or high power consumption, the concept of bandwidth part (BWP) has been introduced. A BWP consists of a contiguous portion of bandwidth within the carrier bandwidth where a single numerology is employed. By defining a small BWP, the computational complexity and power consumption of a UE can be reduced. As each BWP can have a different bandwidth and numerology, BWPs enable a more flexible and efficient use of the resources by dividing the carrier bandwidth for multiplexing transmissions with different configurations and requirements. The term numerology is commonly understood as referring to physical waveform characteristics in terms of subcarrier spacing and corresponding time domain length. In 5G NR, the subcarrier spacing can vary from 15 kHz to 960 kHz as of release 17, and there are 7 types of numerology: SCS 15, 30, 60, 120, 240, 480, 960 Khz. In contrast, in LTE there is only one numerology, which is SCS 15 kHz. Larger SCS allow for lower latency and support higher-frequency bands, while smaller SCS are suitable for lower-frequency bands and increased coverage. The symbol duration in 5G NR is inversely proportional to the SCS. A larger SCS results in a shorter symbol duration, enabling faster data transmission and lower latency.

In 5G NR V2X, a subset of the available SL resources is (pre-)configured to be used by several UEs for their SL transmissions. This subset of available SL resources is referred to as a resource pool (RP) and is illustrated in FIG. 2. A resource pool may comprise any number of neighbouring or consecutive sub channels and multiple consecutive time slots. The resource blocks within an RP are referred to as physical resource blocks (PRB). An RP consists of contiguous PRBs and contiguous or non-contiguous slots that have been (pre-)configured for SL transmissions. An RP must be defined within the SL BWP. Therefore, a single numerology is used within an RP. If a UE has an active uplink (UL) BWP, the SL BWP must use the same numerology as the UL BWP if they are both included in the same carrier. Otherwise, the SL BWP is deactivated. The term numerology is used, inter alia, for the subcarrier spacing of the PRBs and may be expressed in kHz-units.

In the frequency domain, an RP is divided into a (pre-)configured number L of contiguous sub-channels, where a sub-channel consists of a group of consecutive PRBs in a slot. The number M_{sub} of PRBs in a sub-channel corresponds to the sub-channel size, which is (pre-)configured within an RP. In NR V2X SL, the sub-channel size M_{sub} can be equal to 10, 12, 15, 20, 25, 50, 75, or 100 PRBs. A sub-channel represents the smallest unit for a sidelink data transmission or reception. A sidelink transmission can use one or multiple sub-channels. In the time domain, the slots that are part of an RP are (pre-)configured and occur with a periodicity of 10240 ms. The slots that are part of an RP can be (pre-)configured with a bitmap. The length of the bitmap can be equal to 10, 11, 12, . . . , 160.

An RP can be used for all transmission types, i.e., unicast, groupcast, and broadcast, and can be shared by several UEs for their SL transmissions. A UE can be (pre-)configured with multiple RPs for transmission, i.e., transmit RPs, and with multiple RPs for reception, i.e., receive RPs. A UE can then receive data on resource pools used for SL transmissions by other UEs, while the UE can still transmit on the SL using its transmit resource pools.

5GAA release 16 defines two modes, mode 1 and mode 2, for the selection of sub-channels in NR V2X SL communications using the NR V2X PC5 interface. These two modes are the counterparts to modes 3 and 4 in LTE V2X discussed further above. However, while NR V2X supports broadcast, groupcast, and unicast SL communications, LTE V2X only supports broadcast SL communications.

Similar to mode 3 in LTE V2X, in NR mode 1 the gNB, i.e., the network infrastructure, assigns and manages the NR SL radio resources for V2V communications using the NR Uu interface. UEs must therefore be under network coverage to operate using NR mode 1. NR SL radio resources can be allocated from licensed carriers dedicated to NR SL communications or from licensed carriers that share resources between SL and UL communications. The SL radio resources can be configured so that NR mode 1 and NR mode 2 use separate resource pools. The alternative is that NR mode 1 and NR mode 2 share the resource pool. Pool sharing can result in a more efficient use of the resources, but it is prone to potential collisions between NR mode 1 and NR mode 2 transmissions. To solve this, NR mode 1 UEs notify NR mode 2 UEs of the resources allocated for their future transmissions.

NR mode 1 uses dynamic grant (DG) scheduling like LTE V2X mode 3, but replaces the semi-persistent scheduling in LTE V2X mode 3 with a configured grant scheduling. With DG, NR mode 1 UEs must request resources to the base station for the transmission of every single TB. To this end, the UEs must send a Scheduling Request (SR) to the gNB, and the gNB responds by indicating the SL resources, i.e., the slot(s) and sub-channel(s), allocated for the transmission of a TB and up to 2 possible retransmissions of this TB. The UE informs other UEs about the resources it will use to transmit a TB and up to 2 possible retransmissions using the 1st-stage sidelink control information (SCI) messages. Nearby UEs operating under NR mode 2 can then know which resources UEs in NR mode 1 will utilize.

Like with mode 4 in LTE V2X, when using mode 2 in NR V2X UEs can autonomously select their SL resources from a resource pool, i.e., one or several sub-channels. In this case, UEs can operate without network coverage. The resource pool can be (pre-)configured by the gNB when the UE is in network coverage. NR mode 2 and LTE mode 4 differ on the scheduling scheme. LTE mode 4 operates following a sensing-based SPS scheme, while NR mode 2 can operate using a dynamic or an SPS scheme that differs from the one designed for LTE mode 4. The dynamic scheme selects new resources for each TB and can only reserve resources for the retransmissions of that TB. It is noted that in this section it is distinguished between a selected resource and a reserved resource. A reserved resource is a selected resource that a UE reserves for a future transmission by notifying neighbouring UEs using the 1st-stage SCI messages. A UE can select and reserve resources for the transmission of several TBs and their retransmissions when utilizing the SPS scheme. It is important to note that the SPS scheme can be enabled or disabled in a resource pool by corresponding (pre-)configuration.

Large numbers of radio apparatus, or user equipment (UE), communicating either in accordance with the 4G LTE standard or the 5G NR standard may be within a common radio range and require SL communication. As LTE and NR may use identical portions of the available resources, i.e., may operate on the same frequencies or on at least partially overlapping frequency bands wireless apparatus operating in accordance with either one of the standards may try to transmit at the same time within these mutually used frequencies or frequency bands. The resulting colliding access to the same resource can only be avoided by coordinating access to the commonly used resources.

When both LTE and NR UEs are under coverage of their respective networks, reservation and access coordination to the radio resource may be achieved at the network level, i.e., the eNB and the gNB coordinate the resources that are assigned to the respective UEs. LTE and NR radio access (RA) mechanisms, however, are incompatible, even when the messages required for the RA are transmitted on the same frequency. Thus, if either LTE UEs or NR UEs are not covered by their respective network, network-coordinated access for the two incompatible communication types is not available, as the UEs not covered by their network cannot decode the resource reservation of the respective other network and will resort to the respective self-coordination modes.

It is expected that most if not all of the spectrum intended for ITS use will be allocated to LTE SL, leaving limited or no dedicated ITS spectrum to NR. One motivation to prioritize LTE SL in the ITS spectrum is related to the need to enable the basic safety V2X use cases, such as the ones described in 3GPP TS 22.885, in a relatively short term in as many vehicles as possible, for minimizing the occurrence of traffic related accidents and fatalities. As new vehicles that support both LTE SL and NR SL, and farther in the future NR SL only, continue to be introduced into the market, at some point in time there will be enough market penetration to enable the use of advanced V2X use cases, such as the ones described in 3GPP TS 22.886. However, for these advanced V2X use cases to be feasible it is required that enough spectrum is made available for NR SL both in the ITS band and in other non-ITS bands. While the latter case is being tackled by the introduction in NR SL of features such as carrier aggregation, operation in unlicensed band and beam management at FR2, the former is to be enabled via LTE SL and NR SL co-channel co-existence. Co-channel co-existence allows two different, mutually incompatible or not interoperable radio access technologies (RATs), in this case LTE-SL and NR-SL, to make use of the same radio resources. In the present context incompatible or not interoperable may include RATs in which one or both RATs has the capability of receiving and/or decoding a subset of the transmissions of the respective other RAT. A full interoperability, however, is not given.

Overlapping resource pools between two co-existing, mutually incompatible or not interoperable RATs can be avoided using a predefined, rigid resource allocation scheme. FIG. 3A schematically shows an example of a rigid resource allocation scheme. In the rigid resource allocation scheme resource pools are exclusively allocated within the resource to communication in accordance with one of the two communication standards. The light dotted background represents the commonly used resource, i.e., the channels over time, and the reservations for the different communication standards are indicated by the different hashing. Note that there may or may not be unused spaces between the different resource pool reservations, and that the respective reserved resource pools may have varying lengths and widths, i.e., numbers of contiguous sub-channels and time slots. Since the resource allocation is rigid, i.e., fixed, it can be known beforehand in all UEs that operate in accordance with a respective standard. However, while easy to implement, the rigid resource allocation cannot consider different compositions of the respective UEs within the same radio range, i.e., cannot consider cases in which more UEs that communicate in accordance with a first standard are present that those that communicate in accordance with a second standard, and cannot easily be adjusted once implemented in the UEs. Thus, resources in pools reserved for communication in accordance with one standard may go unused, while the resources for communication in accordance with the other standard are insufficient. Generally, this results in inefficiencies whenever the share of UEs of the respective communication standard within the same radio range does not correspond to the respective share in the rigid allocation.

Using unused resource elements reserved for communication in accordance with one communication standard for communication in accordance with the respective other communication standard would increase the use of the overall radio resource and thus the efficiency. However, doing so requires a mechanism to avoid or at least reduce collisions between transmissions in accordance with the two communication standards during such overlapping periods. FIG. 3B exemplarily shows partially overlapping resource pools, where some of the resources intended for communicating in accordance with one standard may be used for communication in accordance with the other standard. Here, the resources used for communication in accordance with the overlapping standard are exclusively reserved for this use. This ‘pool occupation’ will still require some coordination, and may still show inefficiencies, e.g., when the ‘occupied’ part of the pool is not fully used for communication in accordance with the occupying standard, but could have been used for communication in accordance with the other standard.

As mentioned before, not all resource elements, sub-channels and time slots are necessarily used within one resource pool provided for communication in accordance with one communication standard, and the unused resource elements are wasted. FIG. 4 depicts an exemplary LTE resource pool structure showing, inter alia, reserved or allocated resource elements and available resource elements for an adjacent resource assignment and a nonadjacent resource assignment in the physical SL control channel (PSCCH) and the physical SL shared channel (PSSCH). Adjacent and nonadjacent refers to the way the transport blocks (TB) are arranged across the subchannels. Using unused resource elements for communication in accordance with the respective other communication standard would increase the use of the overall resource and thus the efficiency.

The remaining inefficiency may be further reduced by introducing at least partially overlapping resource pools in which the overlapping part is used shared by UEs communicating in accordance with respective non-interoperable communication standards.

FIG. 5 shows a schematic example for partially overlapping resource pools in a frequency range used for co-channel co-existence, where an overlapping part or portion is used shared. As elucidated further above, this is possible without causing any problem when not all of the resource elements in the shared part or portion of the resource pools are already fully assigned for communication in accordance with one of the standards that may have priority access. This situation, i.e., the shared part not being fully assigned for use, may occur more often than not, and the methods proposed herein address situations in which a coordination of the access to the shared resource is not achieved within required parameters.

LTE has been around for a longer time than NR and is widely deployed, and its use in sidelink operation is fully evolved, stipulated and fixed, i.e., will not be modified any more. Thus, optimization of the coordination can only be achieved through corresponding implementation in the NR system.

An aspect of the present invention thus assumes that LTE UE will be capable of resource reservation within a certain range of the resource pool, indicated as Class A in FIG. 5, and will not know about any possible or actual pool sharing in the overlapping part, labelled Class C. The distinction between Class A and Class C may be known to the LTE network, though. Non-legacy NR UE will know the distinction between Class B and Class C, with Class B being a range within the resource pool that may or be not be exclusive or reserved for 5G NR V2X communication. The not shared portion of Class A may be considered exclusive or reserved for 4G LTE V2X communication.

As mentioned further above, the coordination of the resource allocation can either be network-controlled, i.e., the network-through the eNB or gNB-determines and assigns the resources that can be used by a UE in a centralized manner, and the UE simply uses the assigned resources, or UE-controlled. In UE-controlled resource allocation the UEs autonomously and in a distributed manner determine the resources that can be used. Bearing this in mind, RA coordination trouble may arise in scenarios in which UEs exclusively capable of communicating in accordance with the a first standard (UE-A), e.g., the 4G LTE standard, and UEs capable of communicating in accordance with a second standard (UE-B), e.g., the 5G NR standard, are located in areas that have a first standard-only or second standard-only network coverage, e.g., LTE-only or NR-only. In this case, a network-controlled resource allocation will not be known to all UEs within the area of first or second standard-only network coverage, as the resource allocation by the first standard NB is not received or understood by a second standard-only UE-B, and the resource allocation by a second standard NB is not received or understood by a first standard-only UE-A. Hence, the respective UEs that cannot benefit from the network-controlled resource allocation will resort to UE-controlled resource allocation. Since the two resource allocation schemes are not mutually coordinated, allocated resource blocks in a shared resource pool may at least partially overlap, which may result in disturbed or even failed communication attempts due to signal interference.

Coordination trouble may likewise arise in areas without any network coverage at all, when first standard-only UE-A and second standard-only UE-B each try to perform the respective UE-controlled resource allocation. Here, too, the respective UEs that communicate in accordance with respective non-interoperable standards will have no knowledge of the respective other resource allocation, which may result in at least partially overlapping allocated resource pools.

Some second standard-only UE-B may be capable of receiving and decoding some control messages related to the reservation, allocation and use of shared resources that are transmitted in accordance with the first standard. Such capability, however, may require additional hardware and/or software, which implies higher component cost, e.g., for substantially simultaneously decoding control messages that may have different numerologies, and which will require higher computational power and, consequently, higher energy consumption. In addition, such HW may be burdened by trade-offs in order to allow simultaneous decoding of different numerologies in the channel where co-existence is happening.

As briefly mentioned earlier, some wireless apparatus may be equipped with respective communication interfaces for communicating in accordance with the first standard and the second standard, e.g., 4G LTE and 5G NR. These apparatus may also be referred to as dual mode UEs and are designated herein as third-type apparatus, third-type wireless apparatus, or UE-C. As the first-type communication interface of these UE-C is fully capable of receiving and decoding control messages received via the first-type communication interface, in particular those pertaining to resource reservation and allocation in a shared resource pool, there is no benefit when the second-type interface of these third-type apparatus is capable of receiving and decoding control messages related to the reservation, allocation and use of shared resources that are transmitted in accordance with the first standard. Rather, it would be beneficial if the relevant information is internally communicated from the first-type communication interface to the second-type communication interface. To this end the corresponding communication interfaces of such third-type wireless apparatus may be communicatively coupled internally. Nevertheless, since the first- and second-type interfaces in the UE-C are generally independent from each other, both may still receive and decode information pertaining to the coordinated operation in a shared resource.

However, even if the relevant information is internally shared in the third-type apparatus as of yet this shared knowledge remains internal and privy to the respective UE-C, if it is internally shared at all. Thus, even when one or more dual mode UEs are present in the scenarios discussed above, second standard-only UE-B will need to receive and/or decode the control messages on their own.

In light of the discussion above a desire remains to reduce the computational load and/or the power consumption in second- and third-type UEs in at least some situations in which first-, second- and third type UEs are located within a given area and within mutual radio range inside this given area, said UEs using an at least partly shared resource, and in which a full network coverage in accordance with both the first and the second communication standard is not available.

### SUMMARY OF THE INVENTION

An aspect of the present invention aims to provide a method of controlling an operation of second-type wireless interfaces in second- and third-type wireless apparatus that at least partly addresses the aforementioned desire.

An aspect of the present invention presented hereinafter addresses at least some of the shortcomings of the existing technology discussed above by exploiting the capability of dual-mode UEs, third-type wireless apparatus, or UE-C, to internally share information pertaining to the operation of a first-type communication interface that was received via said first-type communication interface with a control module that is configured to control the operation of a second-type communication interface. This capability may not only be used for controlling the operation of the third-type apparatus, or UE-C, but also for transmitting corresponding information or control messages to second-type apparatus, also referred to herein as second-type wireless apparatus, or UE-B, thereby enabling these UE-B to also operate in an operating mode that exhibits a reduced computational power and a reduced energy consumption.

Prior to a detailed presentation of an aspect of the invention a brief overview over exemplary scenarios addressed by an aspect of the invention will be given, using LTE as an example for the first communication standard and 5G NR as an example for the second communication standard. As initially described, both LTE and NR have operating modes in which the respective network is not available and the UEs perform autonomous resource allocation.

FIGS. 6A and 6B show exemplary representations of the situations discussed above. In FIG. 6A only LTE network coverage is provided in an area, in which first standard-only UE-A, second standard-only UE-B and dual mode UE-C are located. In the figure the UE-A are represented by the vehicle with the circle with the vertical hashing, the UE-B are represented by the vehicle with the circle with the horizontal hashing, and the UE-C are represented by the vehicle with the circle with the cross-hashing. The LTE network, represented by the radio tower icon labelled eNB, can only allocate resources to the UE-A and the NR wireless interface of the UE-C, indicated by the arrows. The UE-B will not have knowledge of the resource allocation through the LTE eNB, indicated by the question marks, and will resort to UE-controlled resource allocation performed by the UE-B, which may cause interferences in at least partially overlapping resource pools and/or assigned resources and which may result in insufficient time synchronisation between the UE-B and the UE-A.

In FIG. 6B only NR network coverage is provided in an area, in which first standard-only UE-A, second standard-only UE-B and dual mode UE-C are located. Like in FIG. 6A the UE-A are represented by the vehicle with the circle with the vertical hashing, the UE-B are represented by the vehicle with the circle with the horizontal hashing, and the UE-C are represented by the vehicle with the circle with the cross-hashing. The NR network, represented by the radio tower icon labelled gNB, can only allocate resources to the UE-B and the NR wireless interface of the UE-C, indicated by the arrows. The UE-A will not have knowledge of the resource allocation through the NR gNB, again indicated by the question marks, and will resort to UE-controlled resource allocation performed by the UE-A, which may cause interferences in at least partially overlapping resource pools and/or assigned resources and which may result in insufficient time synchronisation between the UE-B and the UE-A.

FIG. 7 schematically shows a situation in which no network coverage is provided at all in a given area, in which first standard-only UE-A, second standard-only UE-B and dual mode UE-C are located. Like in FIGS. 6A and 6B the UE-A are represented by the vehicle with the circle with the vertical hashing, the UE-B are represented by the vehicle with the circle with the horizontal hashing, and the UE-C are represented by the vehicle with the circle with the cross-hashing. Since no network is available for coordinating radio access, both the UE-A and the UE-B independently perform UE-controlled resource allocation. It is obvious that the UE-A have no knowledge of the allocation agreed to by the UE-B and vice versa, indicated by the questions marks, and that only UE-C that happen to be in the given area can have knowledge of both allocations, indicated by the exclamation marks. In any case, that leaves one or more UEs without a full knowledge of the actual use of the shared resource, which can lead to the communication problems mentioned above.

It is reminded that it is assumed that LTE takes priority over NR in terms of resource allocation and synchronisation, since the standard is set and may not be modified for adapting to the situations described above. Further, sidelink operation, especially in out-of-coverage situations, allows using different synchronization sources, including other UE as sync. reference, which increases the likelihood of insufficient synchronisation between the two mutually not interoperable communication systems accessing the shared resource.

Thus, in accordance with a first aspect of the invention a method of operating a third-type apparatus comprising a first-type wireless interface configured for communication in accordance with a first communication standard and a second-type wireless interface configured for communication in accordance with a second communication standard, in situations in which a network coverage in accordance with at least one of the first or the second communication standard is not present and/or available, is presented. The first-type wireless interface and the second-type wireless interface are communicatively coupled to each other under control of one or more microprocessors of the third-type apparatus. The first- and second-type wireless interfaces and/or the first and second communication standards are generally not interoperable and use an at least partly shared radio resource. In this context, generally not interoperable may permit a limited capability of the second-type wireless interface to receive and decode a subset of transmissions in accordance with a first communication standard, in particular transmissions carrying control information pertaining to the use of a radio resource that is at least partly shared for communication in accordance with either of the first and the second communication standards. Receiving a subset may include receiving said subset on a communication channel that has different physical properties, including, e.g., different subcarrier spacing and time durations of time slots. The second-type wireless interface of the third-type apparatus may be configured to operate with a subcarrier spacing (SCS) that is a multiple of an SCS of the first-type wireless interface of the third-type apparatus. A full compatibility of the second-type wireless interface with communication in accordance with the first communication standard is not given, however. The at least partly shared resource extends over a number of consecutive subcarriers and over time. Resource elements within the partly shared radio resource may comprise physical resource blocks, channels, sub-channels, or groups thereof, and may further comprise time slots, or any combination of any of the aforementioned elements. The expression partly shared may be interpreted as relating to the simultaneous, respectively exclusive use of channels, sub-channels, or time slots of the radio resource for communications via wireless interfaces of the first and the second type.

The first-aspect method comprises a step of determining whether or not a network coverage of a network in accordance with the first and/or the second communication standard is present and/or available. In the positive case the method may be stopped or, preferably, started over in a continuous or repetitive manner.

If network coverage in accordance with the first communication standard is not present and/or available, while network coverage in accordance with the second communication standard is present and available the method comprises internally forwarding information pertaining to the use of a shared radio resource that was previously received via the first-type wireless interface to a second control module associated with the second-type wireless interface, and controlling the operation of the latter accordingly. Internally forwarding the information may be effected via a first control module associated with the first communication interface. The control modules of the first-type and the second-type communication interfaces may each be implemented in hardware and/or software, and may also comprise and/or control elements and components typically found in a general wireless communication interface such as, e.g., a signal mapper and de-mapper, a modulator and demodulator, transmit power controller, a gain control circuit (AGC), a transmit amplifier, a receive amplifier, a digital-to-analogue converter (DAC), an analogue-to-digital converter (ADC) and other electronic circuitry.

Throughout this specification control modules associated with first-type wireless interfaces in third-type apparatus may have common elements with control modules associated with second-type wireless interfaces thereof, e.g., when the actual function of the control module associated with the first-type or second-type wireless interface is implemented as computer program instructions, these may be executed by the same physical microprocessor or physical or logical core thereof, using the same physical volatile memory. Control modules associated with the first-type wireless interface or with the second-type wireless interface, or both, may comprise, inter alia, one or more microprocessors, associated volatile and non-volatile memory, and may execute computer program instructions, stored in the non-volatile memory, that execute decoding, coding, inter-apparatus sharing of information, and/or control of physical elements of wireless interfaces or other elements of the apparatus it is provided in.

In a further step of the first-aspect method a control message pertaining to selectively enabling or disabling an operation mode of the second-type wireless interfaces of the second-type apparatus is transmitted via the second-type wireless interface, in which operation mode transmissions carrying information related to the reservation, allocation and/or use of shared resources that are transmitted in accordance with the first standard are received and/or decoded. The control message transmitted via the second-type wireless interface of the third-type apparatus is targeting one or more second-type apparatus within radio range or targeting a base station of the network providing coverage in accordance with the second communication standard. In addition or alternatively, at least a relevant part of the corresponding information that was previously internally forwarded to the second control module associated with the second-type communication interface may be transmitted, via the second communication interface, to second-type apparatus within radio range or to the base station.

In case the transmissions are targeted to a base station the control message pertaining to selectively enabling or disabling an operation mode of the second-type communication interfaces of the second-type apparatus, in which operation mode information related to the reservation, allocation and use of shared resources that are transmitted in accordance with the first standard are received and/or decoded, may be forwarded to second-type apparatus by the base station.

If only at least a relevant part of the corresponding information that was previously internally forwarded to the second control module associated with the second-type communication interface is transmitted to via the second communication interface to second-type apparatus within radio range or to the base station, the targeted recipients of the transmission will use this for accordingly enabling or disabling the operating mode of their second-type interface, in which in which operation mode transmissions carrying information related to the reservation, allocation and/or use of shared resources that are transmitted in accordance with the first standard are received and/or decoded.

In an alternative embodiment of the first-aspect method, if network coverage in accordance with the second communication standard or in accordance with both the first and the second communication standards is not present and/or available, the method comprises, like in the embodiment previously described, internally forwarding information pertaining to the use of a shared radio resource that was previously received via the first-type communication interface to a second control module associated with the second-type communication interface. Likewise, in a further step of the alternative embodiment of the first-aspect method a control message pertaining to selectively enabling or disabling an operation mode of the second-type wireless interfaces of the second-type apparatus is transmitted via the second-type wireless interface, in which operation mode transmissions carrying information related to the reservation, allocation and/or use of shared resources that are transmitted in accordance with the first standard are received and/or decoded. In the alternative embodiment of the first-aspect method, however, the control message transmitted via the second-type wireless interface of the third-type apparatus is exclusively targeting one or more second-type apparatus within radio range. Similarly, in addition or alternatively to transmitting the control message, at least a relevant part of the corresponding information that was previously internally forwarded to the second control module associated with the second-type communication interface may be transmitted, via the second communication interface, exclusively to second-type apparatus within radio range.

In both alternatives described above the additional or alternative transmission may comprise broadcasting or group-casting said information.

In accordance with one or more embodiments the method in accordance with the first aspect of the invention further comprises sensing if one or more second-type apparatus are within radio range of the third-type apparatus, The forwarding step and the subsequent one or more transmitting steps may be executed only in the positive case. Implementing such sensing is simple and straightforward, requiring only information that is available anyway from the second-type wireless interface. This embodiment may further reduce the power consumption of the third-type apparatus.

In accordance with one or more embodiments the method in accordance with the first aspect of the invention further comprises repeating the determining step continuously or at intervals. Depending on the result of the determining step, correspondingly adapted control messages and/or relevant parts of the corresponding information that was previously internally transmitted to the second control module associated with the second-type communication interface may be transmitted. This embodiment may also address the case when the selective enabling or disabling of the operation mode of the second-type communication interfaces of the second-type apparatus, in which operation mode transmissions carrying information related to the reservation, allocation and use of shared resources that are transmitted in accordance with the first standard are received and/or decoded, is valid for a predetermined time interval only and would be reverted to a default setting in the absence of a further or subsequent control message. The predetermined time interval may be pre-set in the respective second-type wireless interface or may be determined by a value transmitted in a respective control message.

In accordance with one or more embodiments the method in accordance with the first aspect of the invention further comprises comparing the numerologies present at the first-type wireless interface and the second-type wireless interface of the third-type apparatus. The determining step, the forwarding step and the transmitting steps may be invoked only if the numerologies differ from each other. This embodiment may address the issue that a higher computational power and/or a higher power consumption is required in particular in case of different numerologies being used in the two communication standards. Selectively not transmitting control messages may, in this embodiment, reduce the communication overhead.

In accordance with a second aspect of the invention a third-type wireless apparatus or communication device is presented. The third-type wireless apparatus or communication device comprises at least one transmitting and/or receiving antenna and associated electronic radio frequency circuitry, which may be of conventional design. The aforementioned components, circuitry and elements provide or implement at least one first-type wireless interface and at least one second-type wireless interface. The third-type wireless apparatus or communication device further comprises one or more microprocessors and associated volatile and non-volatile memory. The aforementioned elements, circuitry and components are communicatively connected via one or more signal or data connections or buses. The non-volatile memory stores computer program instructions which, when executed by the one or more microprocessors, configure the wireless apparatus or communication device for performing one or more embodiments of the method in accordance with the first aspect of the invention presented above.

In accordance with a third aspect of the invention, a method of operating a second-type apparatus comprising a second-type wireless interface configured for communication in accordance with a second communication standard that is generally not interoperable with a first communication standard is presented. Despite the first and the second communication standards being generally not interoperable the second-type wireless interface is further configured for receiving and decoding a subset of transmissions in accordance with a first communication standard, said subset carrying control information pertaining to the use of a radio resource that is at least partly shared for communication in accordance with either of the first and the second communication standards. Reference is made to the description of the method in accordance with the first aspect of the invention further above for an explanation of the meaning of ‘not interoperable’ in the context of the present invention.

The third-aspect method comprises receiving, via the second-type wireless interface and from a third-type apparatus or from a base station of a network providing coverage in accordance with the second communication standard, a control message pertaining to selectively enabling or disabling an operation mode of the second-type wireless interface of the second-type apparatus, in which operation mode transmissions carrying information related to the reservation, allocation and/or use of shared resources that are transmitted in accordance with the first standard are received and/or decoded. In addition or alternatively, at least a relevant part of information pertaining to the use of a shared radio resource by first-type apparatus within radio range may be received via the second-type wireless interface and from a third-type apparatus or from the base station of the network providing coverage in accordance with the second communication standard. The method further comprises operating the second-type wireless interface of the second-type apparatus in accordance with the received control message and/or the received relevant part of information pertaining to the use of a shared radio resource by first-type apparatus within radio range, by accordingly enabling or disabling receiving and/or decoding the subset of transmissions in accordance with the first communication standard carrying control information pertaining to the use of the shared radio resource.

In accordance with one or more embodiments of the method in accordance with the third aspect of the invention operating the second-type interface of the second-type apparatus in accordance with the offset category further comprises, when receiving and/or decoding a subset of transmissions in accordance with a first communication standard carrying control information pertaining to the use of the shared radio resource is disabled, receiving information pertaining to the use of the shared radio resource exclusively in transmissions in accordance with the second communication standard.

In accordance with one or more embodiments the method in accordance with the third aspect of the invention further comprises reverting operation of the second-type wireless interface of the second-type apparatus to a default mode after expiry of a predetermined time after a control message has been received.

In accordance with a fourth aspect of the invention, a second-type wireless apparatus or communication device is presented. The wireless apparatus or communication device comprises at least one transmitting and/or receiving antenna and associated electronic radio frequency circuitry, providing at least one second-type communication interface configured for communication in accordance with a second communication standard that is generally not interoperable with a first communication standard. Despite the first and the second communication standards being generally not interoperable the second-type wireless interface may be further configured for receiving and decoding a subset of transmissions in accordance with a first communication standard, said subset carrying control information pertaining to the use of a radio resource that is at least partly shared for communication in accordance with either of the first and the second communication standards. Reference is made to the description of the method in accordance with the first aspect of the invention further above for an explanation of the meaning of ‘not interoperable’ in the context of the present invention. The wireless apparatus or communication device further comprises one or more microprocessors and associated volatile and non-volatile memory. The aforementioned elements are communicatively connected via one or more signal or data connections or buses. The non-volatile memory stores computer program instructions which, when executed by the one or more microprocessors configure the wireless communication apparatus for executing one or more embodiments of the method in accordance with the third aspect of the invention described hereinbefore.

As is readily apparent from the foregoing description, a second-type base station of a network configured for wireless communication in accordance with a second communication standard may also contribute to achieving an aspect of the invention. Thus, in accordance with a fifth aspect of the invention, a method of operating such second-type base station is presented. The fifth-aspect method comprises, if resource allocation information for first-type apparatus within a given area covered by said second-type base station is not available from a corresponding first-type base station configured for wireless communication in accordance with a first communication standard, receiving, from a third-type wireless apparatus in accordance with the second aspect of the present invention, a control message pertaining to selectively enabling or disabling an operation mode of second-type communication interfaces of second-type apparatus in accordance with the fourth aspect of the present invention located in said given area, in which operation mode transmissions carrying information related to the reservation, allocation and/or use of shared resources that are transmitted in accordance with the first standard are received and/or decoded. The control message may be received via a second-type wireless interface of the second-type base station. In addition or alternatively, at least a relevant part of information pertaining to the use of a shared radio resource by first-type apparatus within the given area may be received via the second-type wireless interface and from said third-type apparatus. The second-type base station then transmits a corresponding downlink (DL) control message to second-type apparatus located in said given area.

In accordance with one or more embodiments of the method in accordance with the fifth aspect of the invention the DL control message is transmitted as a broadcast V2X app message, a 5G NR DCI format message, or a system information message.

In accordance with a sixth aspect of the invention, a second-type base station of a network configured for wireless communication in accordance with a second communication standard comprises one or more microprocessors, volatile memory, non-volatile memory, and a second-type wireless interface for communicating with one or more third-type wireless apparatus or communication devices in accordance with the second aspect of the present invention and/or with one or more second-type wireless apparatus or communication devices in accordance with the fourth aspect of the present invention. The second-type base station further comprises a third-type communication interface for communicating with one or more network elements of a network configured for providing wireless communication in accordance with a first communication standard. The aforementioned elements are communicatively connected via one or more signal or data connections or buses. The non-volatile memory stores computer program instructions which, when executed by the one or more microprocessors, configure the second-type base station (gNB) for performing the method in accordance with the fifth aspect of the present invention.

In accordance with one or more embodiments of the method in accordance with the first third and fifth aspects of the invention the control message comprises a single bit whose status or value indicates that the operation mode of the second-type communication interfaces of the second-type apparatus, in which operation mode control messages related to the reservation, allocation and use of shared resources that are transmitted in accordance with the first standard are received and/or decoded, may be enabled or disabled, respectively.

While the control message may be transmitted or received in a general broadcast transmission, in accordance with one or more embodiments of the methods in accordance with aspects of the invention presented herein the second communication standard comprises messages carrying sidelink control information (SCI) that are transmitted via a physical control channel, including via a physical sidelink control channel (PSCCH). Transmitting or receiving, respectively, a control message via the second-type interface may comprise transmitting or receiving, respectively, said control message via a first-stage control information, including via a first-stage sidelink control information (SCI-1).

In NR radio the SCI may be transmitted in two phases or parts, SCI-1 and SCI-2. The SCI-1 is transmitted over the PSCCH and it is intended to be decoded by all UE. In accordance with an implementation of this embodiment to NR, a new specific format for the SCI-1 may be defined, in which one bit from the reserved field is used, e.g., for signalling whether to enable or disable the operation mode of the second-type communication interfaces of the second-type apparatus, in which control messages related to the reservation, allocation and use of shared resources that are transmitted in accordance with the first standard are received and/or decoded. As up to four bits are configurable for extending the standard, this is conceptually possible and quite convenient.

In accordance with one or more embodiments of the methods in accordance with the invention presented herein the first-stage control information comprises information specifying a second-stage control information, including a second-stage sidelink control information (SCI-2). The second-stage control information may be accessible or decodable after decoding the first-stage control information.

While in this embodiment decoding the SCI-1 is required, it may provide more flexibility, as the size of the SCI-2 message can be indicated and offers more options for addressing the offset, in particular addressing offsets in connection with higher numerologies of second-type communication standards. FIG. 8 shows a schematic diagram illustrating the transmission paths of information in NR radio. The logical sidelink traffic channel (STCH) and the logical sidelink control channel (SCCH) are mapped on the sidelink shared channel (SL-SCH) transport channel, which is mapped on the physical sidelink shared channel (PSSCH) and the physical sidelink control channel (PSCCH). SCI-1 from the two-stage SCI is mapped on the PSSCH, while SCI-2 is mapped on the PSCCH.

FIG. 9 shows a simplified relationship between SCI1 and SCI-2 within a PSSCH transmission.

In the embodiments using first-stage SCI-1 and second-stage SCI-2 messages it is particularly simple to specify a time period indicating for how long the operation mode of the second-type communication interfaces of the second-type apparatus, in which control messages related to the reservation, allocation and use of shared resources that are transmitted in accordance with the first standard are received and/or decoded, are to be enabled or disabled, or a time period after which said operating mode is to be enabled if no such control messages are received prior to the expiration of the time period. It may also be possible to specify geo-coordinates, e.g., for an area, in which said operation mode is to be enabled or disabled.

The methods according to aspects of the invention presented herein enable reductions in the power consumption and a momentary required computational power in situations in which wireless apparatus operating in accordance with different, mutually not interoperable standards use a shared radio resource through the use of dual-mode UEs configured for executing at least some of the methods. Such use of a shared radio resource may include so-called sidelink communication. In these situations the dual-mode UEs internally share information about use of resource elements in the shared resource as reserved or intended for use by UEs operating in accordance with the first communication standard, and forward such information to UEs that are limited to communicating in accordance with the second communication standard, for accordingly modifying the operation of the second-type wireless interfaces. The methods presented herein are backward-compatible with existing resource reservation and allocation schemes of LTE and NR.

The various aspects, and developments and embodiments thereof, presented hereinbefore may individually or interconnectedly address one or more of the problems initially discussed.

The methods described hereinbefore may be represented by computer program instructions. Accordingly, a computer program product comprises computer program instructions which, when executed by a microprocessor of a wireless apparatus, communication device or network component cause the microprocessor to execute methods in accordance with one or more of the methods of aspects of the present invention presented herein, and to accordingly control hardware and/or software blocks or modules of the wireless apparatus, communication device or network component in accordance with aspects of the invention as likewise presented herein.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

While an aspect of the invention has been discussed with a focus on 4G LTE and 5G NR as examples for mutually not interoperable standards it is obvious that the an aspect of present invention can be used with great advantage in all communication scenarios in which communication in accordance with mutually non-interoperable standards occurs in the same or at least overlapping resources, e.g., frequency channels and time slots, in particular when the mutually non-interoperable standards use different subchannel spacing. A particularly useful application of an aspect of the invention is the side link communication in vehicle-to-X (V2X) communication scenarios in the ITS frequency spectrum.

### BRIEF DESCRIPTION OF THE DRAWING

Aspects of the invention will now be described with reference to the drawing, in which

FIG. 1 schematically illustrates the channelization in LTE V2X mode 4 sensing-based SPS scheduling with an exemplary length T=100 ms,

FIG. 2 schematically illustrates the concept of resource pools,

FIGS. 3A and 3B show examples of overlapping resource pools in a channel used by two otherwise not-interoperable radio access technologies,

FIG. 4 depicts an exemplary LTE resource pool structure showing, inter alia, reserved or allocated resource elements and available resource elements for an adjacent resource assignment and a nonadjacent resource assignment in the physical SL control channel (PSCCH) and the physical SL shared channel (PSSCH),

FIG. 5 shows a schematic example for overlapping resource pools in a frequency channel used for co-channel co-existence, where an overlapping part or portion is used shared,

FIGS. 6A and 6B show exemplary representations of situations addressed by an aspect of the present invention in the presence of at least one radio access network,

FIG. 7 shows an exemplary representation of a situation addressed by an aspect of the present invention when no radio access network is present,

FIG. 8 shows a schematic diagram illustrating the transmission paths of information in NR radio,

FIG. 9 shows a simplified relationship between SCI1 and SCI-2 within a PSSCH transmission,

FIG. 10 shows an exemplary schematic block diagram of a third-type wireless apparatus or communication device in accordance with an aspect of the present invention,

FIG. 11 shows an exemplary schematic block diagram of a second-type wireless apparatus in accordance with an aspect of the present invention,

FIG. 12 shows an exemplary schematic block diagram of a second-type base station in accordance with an aspect of the present invention, and

FIG. 13 shows the main steps of the methods in accordance with the first, third and fifth aspects of the invention in relation to each other, further showing message exchanges between them.

In the figures identical or similar elements may be referenced using the same reference designators.

### DETAILED DESCRIPTION OF EXEMPLARY EMBODIMENTS

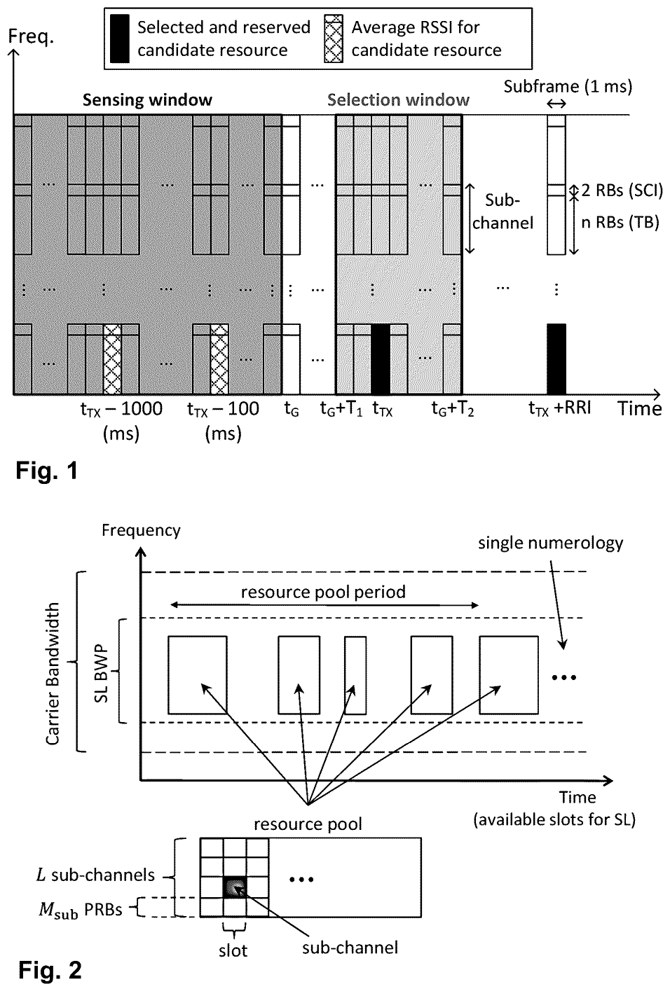

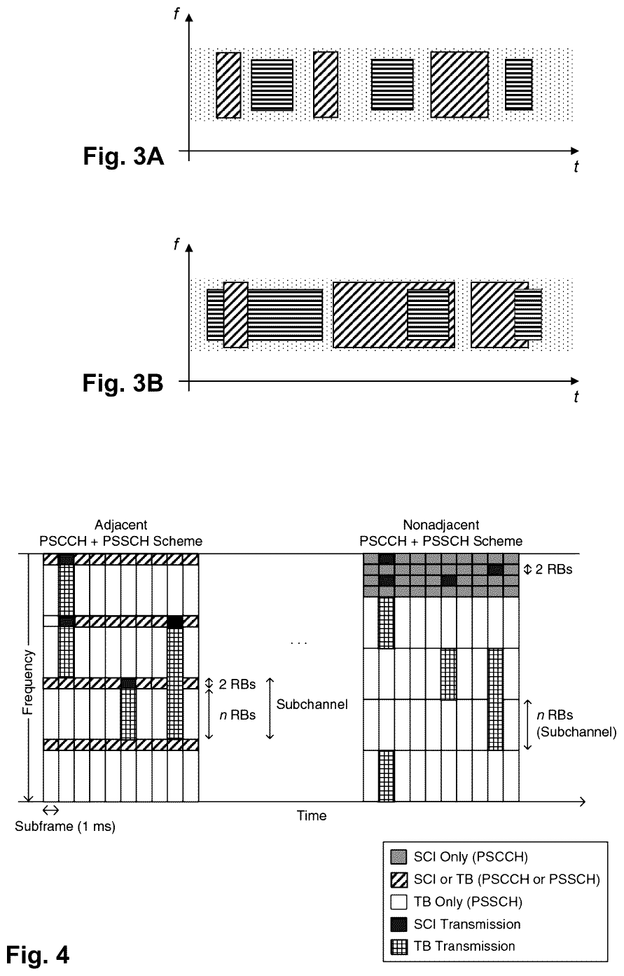

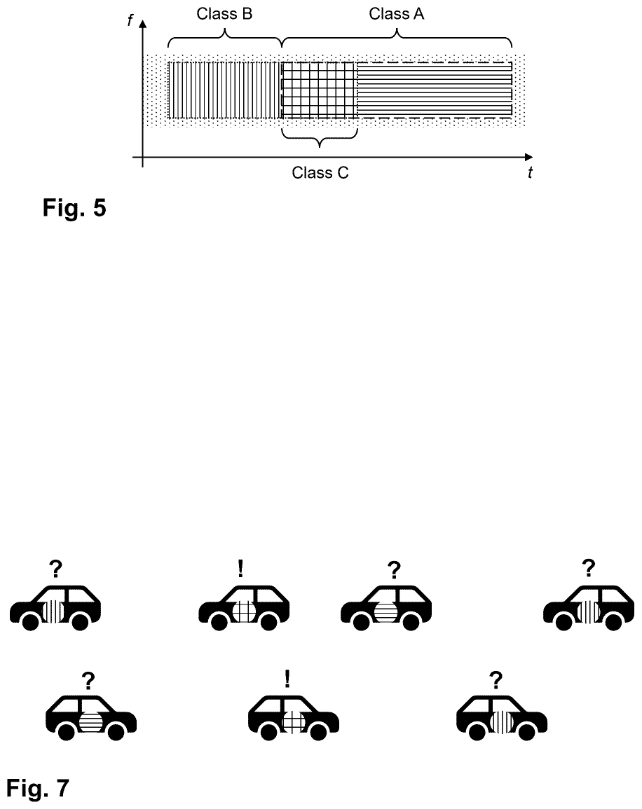

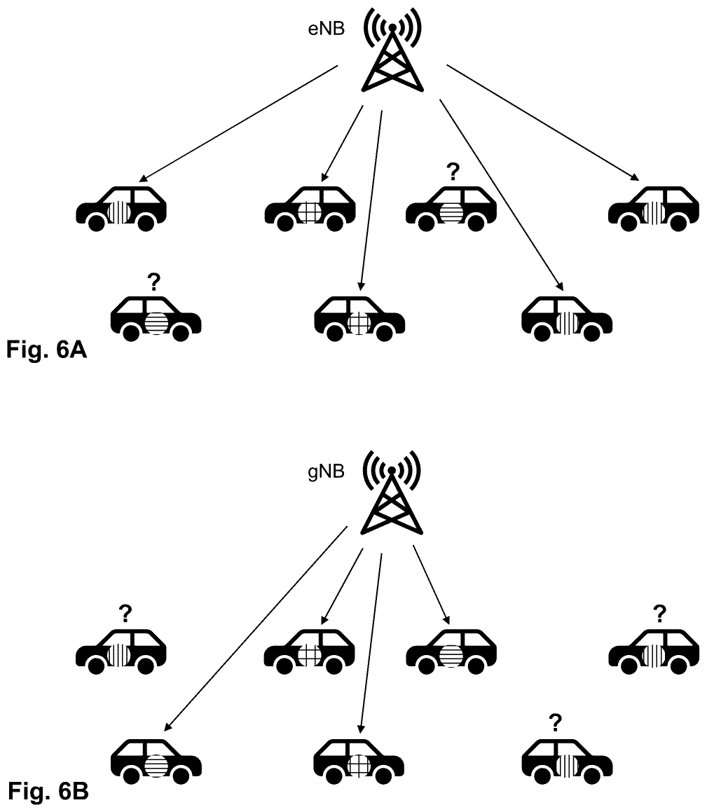

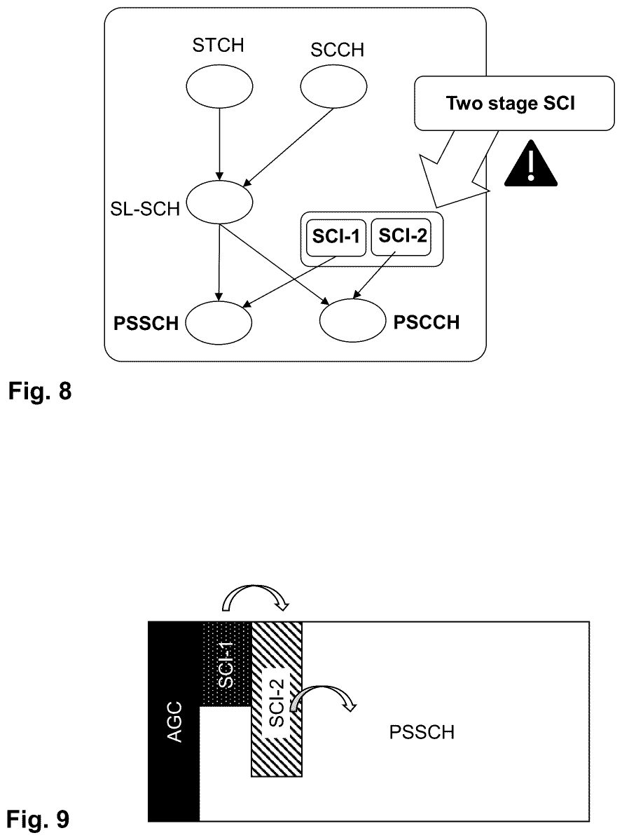

FIGS. 1 to 9 have already been discussed further above and will not be addressed again.

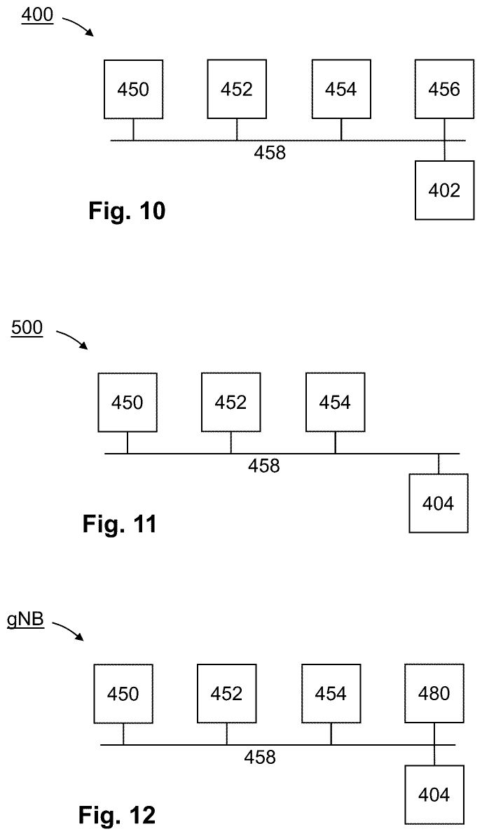

FIG. 10 shows an exemplary schematic block diagram of a third-type wireless apparatus or communication device UE-C in accordance with the second aspect of the present invention. The wireless apparatus or communication device UE-C comprises one or more antennas 402 and associated wireless interface circuitry 456, providing at least one first-type wireless interface and one second-type wireless interface, for communicating with one or more second-type wireless apparatus or communication devices UE-B or a second-type base station gNB (both not shown in the figure), and further comprises one or more microprocessors 450, volatile memory 452 and non-volatile memory 454. The aforementioned elements are communicatively connected via one or more signal or data connections or buses 458. The non-volatile memory 454 stores computer program instructions which, when executed by the one or more microprocessors 450, cause the wireless apparatus or communication device UE-C to execute the method according to the first aspect of the invention as presented hereinbefore.

FIG. 11 shows an exemplary schematic block diagram of a second-type wireless apparatus UE-B in accordance with the fourth aspect of the present invention. The second-type wireless apparatus UE-B comprises one or more microprocessors 450, volatile memory 452, non-volatile memory 454, and a second-type wireless interface 404 for communicating with one or more further second-type wireless apparatus and/or with one or more third-type wireless apparatus or communication devices UE-C in accordance with the second aspect of the present invention (not shown in the figure). The aforementioned elements are communicatively connected via one or more signal or data connections or buses 458. The non-volatile memory 454 stores computer program instructions which, when executed by the one or more microprocessors 450, cause the network component UE-B to execute the method according to the third aspect of the invention as presented hereinbefore.

FIG. 12 shows an exemplary schematic block diagram of a second-type base station gNB of a network configured for wireless communication in accordance with a second communication standard in accordance with the sixth aspect of the present invention. The second-type base station gNB comprises one or more antennas 402 and associated wireless interface circuitry 456, providing at least one second-type wireless interface, for communicating with one or more second- or third-type wireless apparatus or communication devices 400, 500 (not shown in the figure), and further comprises one or more microprocessors 450, volatile memory 452 and non-volatile memory 454. The second-type base station gNB yet further comprises a third-type communication interface 480 for communicating with one or more network elements of a network configured for providing wireless communication in accordance with a first communication standard (not shown in the figure). The aforementioned elements are communicatively connected via one or more signal or data connections or buses 458. The non-volatile memory 454 stores computer program instructions which, when executed by the one or more microprocessors 450, cause the second-type base station gNB execute the method according to the fifth aspect of the invention as presented hereinbefore.

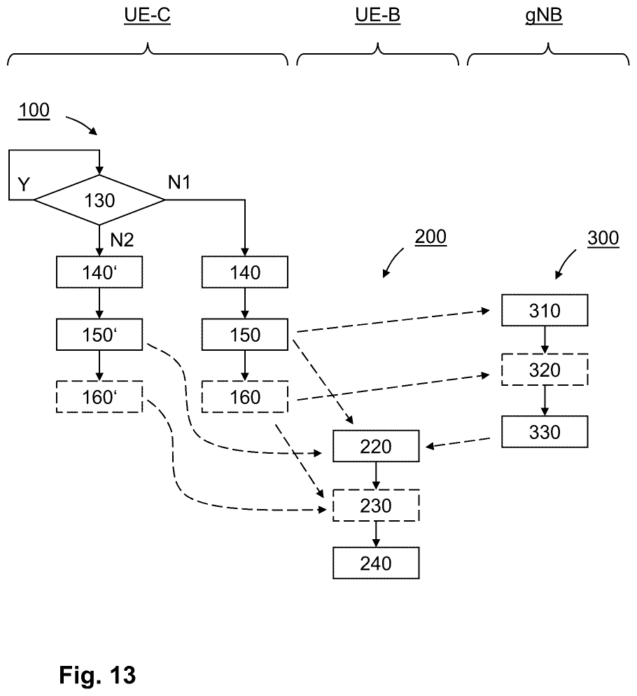

FIG. 13 shows the main steps of the methods 100, 200 and 300 in accordance with the first, third and fifth aspects of the invention, respectively, in relation to each other, further showing message exchanges between them. In step 130 the third-type apparatus UE-C determines presence and/or availability of a network coverage in accordance with the first and/or the second communication standard.

If network coverage in accordance with the first and the second communication standard is available, the method may simply continue checking, “Y”-branch of step 130, repeating step 130 continuously or periodically.

If network coverage in accordance with the first communication standard is not present and/or available, while network coverage in accordance with the second communication standard is present and available, “N1”-branch of step 130, the method internally forwards, in step 140, information pertaining to the use of a shared radio resource that was previously received via the first-type wireless interface to a second control module associated with the second-type wireless interface, and controls the operation of the latter accordingly. In step 150 a control message pertaining to selectively enabling or disabling an operation mode of the second-type communication interface of the second-type apparatus UE-B is transmitted via the second-type wireless interface of the third-type apparatus UE-C, in which operation mode transmissions carrying information related to the reservation, allocation and/or use of shared resources that are transmitted in accordance with the first standard are received and/or decoded. The transmission is targeting one or more second-type apparatus within radio range or targeting a base station gNB of the network providing coverage in accordance with the second communication standard. Note that the message flow in the figure is indicated by the dashed-line arrows. In an additional or alternative step 160, indicated by the dashed outline of the box, at least a relevant part of the corresponding information that was previously internally forwarded to the second control module associated with the second-type communication interface is transmitted to second-type apparatus UE-B within radio range or to the base station gNB via the second communication interface of the third-type apparatus UE-C.

If network coverage in accordance with the second communication standard or in accordance with both the first and the second communication standards is not present and/or available “N2”-branch of step 130, the method internally forwards, in step 140′, information pertaining to the use of a shared radio resource that was previously received via the first-type wireless interface to a second control module associated with the second-type wireless interface, and controls the operation of the latter accordingly. In step 150′ a control message pertaining to selectively enabling or disabling an operation mode of the second-type communication interface of the second-type apparatus UE-B is transmitted via the second-type wireless interface of the third-type apparatus UE-C, in which operation mode transmissions carrying information related to the reservation, allocation and/or use of shared resources that are transmitted in accordance with the first standard are received and/or decoded. In this case, the transmission is only targeting one or more second-type apparatus UE-B within radio range. In an additional or alternative step 160′ at least a relevant part of the corresponding information that was previously internally forwarded to the second control module associated with the second-type communication interface is transmitted to second-type apparatus UE-B within radio range via the second communication interface of the third-type apparatus UE-C.

In step 220 of method 200 the second-type wireless apparatus UE-B receives, via its second-type wireless interface and from a third-type apparatus UE-C or from a base station gNB of a network providing coverage in accordance with the second communication standard, a control message pertaining to selectively enabling or disabling an operation mode of the second-type wireless interface of the second-type apparatus UE-B, in which operation mode transmissions carrying information related to the reservation, allocation and/or use of shared resources that are transmitted in accordance with the first standard are received and/or decoded. In an additional or alternative step 230 at least a relevant part of information pertaining to the use of a shared radio resource by first-type apparatus within radio range is received, via the second-type wireless interface, from a third-type apparatus UE-C or from the base station gNB of the network providing coverage in accordance with the second communication standard. In step 240 the second-type wireless interface of the second-type apparatus UE-B is operated in accordance with the received control message and/or the received relevant part of information pertaining to the use of a shared radio resource by first-type apparatus within radio range, by accordingly enabling or disabling receiving and/or decoding the subset of transmissions in accordance with the first communication standard carrying control information pertaining to the use of the shared radio resource.

If resource allocation information for first-type apparatus within a given area covered by a second-type base station gNB is not available from a corresponding first-type base station eNB covering said given area, said second-type base station gNB receives, in step 310 of method 300, a control message pertaining to selectively enabling or disabling an operation mode of second-type communication interfaces of second-type apparatus UE-B located in said given area, in which operation mode transmissions carrying information related to the reservation, allocation and/or use of shared resources that are transmitted in accordance with the first standard are received and/or decoded. The control message is received from a third-type wireless apparatus (UE-C) via the second-type wireless interface of the second-type base station gNB. In an additional or alternative step 320 at least a relevant part of information pertaining to the use of a shared radio resource by first-type apparatus within the given are is received, via the second-type wireless interface, from a third-type wireless apparatus UE-C. In step 330 the second-type base station gNB transmits a corresponding downlink (DL) control message to second-type wireless apparatus UE-B located in said given area.

### LIST OF REFERENCE NUMERALS (PART OF THE DESCRIPTION)

| | |
|---|---|
| 100 | method |
| 110 | sensing |
| 120 | comparing |
| 130 | determining |
| 140, 140′ | forwarding |
| 150, 150′ | transmitting |
| 160, 160′ | transmitting |
| 200 | method |
| 220 | receiving |
| 230 | receiving |
| 240 | operating |
| 250 | receiving |
| 300 | method |
| 310 | receiving |
| 320 | receiving |
| 330 | transmitting |
| 400 | apparatus/communication |
| | device |
| 402 | antenna |
| 450 | microprocessor |
| 452 | volatile memory |
| 454 | non-volatile memory |
| 456 | wireless interface circuitry |
| 458 | signal/data connection/bus |
| 480 | third-type communication |
| | interface |
| eNB | first-type base station |
| gNB | second-type base station |
| UE-A | first-type wireless |
| | apparatus |
| UE-B | second-type wireless |
| | apparatus |
| UE-C | third-type wireless |
| | apparatus |

1. A method of operating a third-type apparatus comprising a first-type wireless interface configured for communication in accordance with a first communication standard and a second-type wireless interface configured for communication in accordance with a second communication standard, in situations in which a network coverage in accordance with at least one of the first or the second communication standard is not present and/or available, wherein the first- and second-type wireless interfaces and/or communication standards are generally not interoperable and use an at least partly shared radio resource, and wherein the first-type wireless interface and the second-type wireless interface are communicatively coupled under control of one or more microprocessors of the third-type apparatus, the method comprising:
determining presence and/or availability of a network coverage in accordance with the first and/or the second communication standard,
and,
if network coverage in accordance with the first communication standard is not present and/or available, while network coverage in accordance with the second communication standard is present and available:
internally forwarding information pertaining to the use of a shared radio resource that was previously received via the first-type wireless interface to a second control module associated with the second-type wireless interface, and controlling the operation of the latter accordingly,
transmitting, via the second-type wireless interface and targeting one or more second-type apparatus within radio range or targeting a base station of the network providing coverage in accordance with the second communication standard, a control message pertaining to selectively enabling or disabling an operation mode of the second-type communication interface of the second-type apparatus, in which operation mode transmissions carrying information related to the reservation, allocation and/or use of shared resources that are transmitted in accordance with the first standard are received and/or decoded, and/or
transmitting, via the second communication interface to second-type apparatus within radio range or to the base station, at least a relevant part of the corresponding information that was previously internally forwarded to the second control module associated with the second-type communication interface,
or,
if network coverage in accordance with the second communication standard or in accordance with both the first and the second communication standards is not present and/or available:
internally forwarding information pertaining to the use of a shared radio resource that was previously received via the first-type communication interface to a second control module associated with the second-type communication interface,
transmitting, via the second communication interface and targeting one or more second-type apparatus within radio range, a control message pertaining to selectively enabling or disabling an operation mode of the second-type communication interface of the second-type apparatus, in which operation mode transmissions carrying information related to the reservation, allocation and use of shared resources that are transmitted in accordance with the first standard are received and/or decoded, and/or
transmitting, via the second communication interface to second-type apparatus within radio range, at least a relevant part of the corresponding information that was previously internally forwarded to the second control module associated with the second-type communication interface.

2. The method of claim 1, further comprising:
sensing if one or more second-type apparatus are within radio range, and executing the forwarding step and the subsequent one or more transmitting steps only in the positive case.

3. The method of claim 1, further comprising:
continuously or at intervals repeating the determining step, and transmitting correspondingly adapted control messages and/or relevant parts of the corresponding information that was previously internally transmitted to the second control module associated with the second-type communication interface.

4. The method of claim 1, further comprising:
comparing the numerologies present at the first-type wireless interface and the second-type wireless interface, and invoking the determining step, the forwarding step and the transmitting steps only if the numerologies differ from each other.

5. A third-type wireless apparatus or communication device comprising at least one transmitting and/or receiving antenna and associated electronic radio frequency circuitry providing or implementing at least one first-type wireless interface and at least one second-type wireless interface, further comprising one or more microprocessors and associated volatile and non-volatile memory, wherein the aforementioned elements are communicatively connected via one or more signal or data connections or buses, wherein the non-volatile memory stores computer program instructions which, when executed by the one or more microprocessors, configure the third-type wireless apparatus or communication device for performing a method of claim 1.

6. A method of operating a second-type apparatus comprising a second-type wireless interface configured for communication in accordance with a second communication standard that is generally not interoperable with a first communication standard, wherein the second-type wireless interface is further configured for receiving and decoding a subset of transmissions in accordance with said first communication standard, said subset carrying control information pertaining to the use of a radio resource that is at least partly shared for communication in accordance with either of the first and the second communication standards,
wherein the method comprises:
receiving, via the second-type wireless interface and from a third-type apparatus or from a base station of a network providing coverage in accordance with the second communication standard, a control message pertaining to selectively enabling or disabling an operation mode of the second-type wireless interface of the second-type apparatus, in which operation mode transmissions carrying information related to the reservation, allocation and/or use of shared resources that are transmitted in accordance with the first standard are received and/or decoded, and/or receiving, via the second-type wireless interface and from a third-type apparatus or from the base station of the network providing coverage in accordance with the second communication standard, at least a relevant part of information pertaining to the use of a shared radio resource by a first-type apparatus within radio range,
and wherein the method further comprises:
operating the second-type wireless interface of the second-type apparatus in accordance with the received control message and/or the received relevant part of information pertaining to the use of a shared radio resource by the first-type apparatus within radio range, by accordingly enabling or disabling receiving and/or decoding the subset of transmissions in accordance with the first communication standard carrying control information pertaining to the use of the shared radio resource.

7. The method of claim 6, wherein operating the second-type interface of the second-type apparatus in accordance with the offset category further comprises, when receiving and/or decoding a subset of transmissions in accordance with a first communication standard carrying control information pertaining to the use of the shared radio resource is disabled:
receiving information pertaining to the use of the shared radio resource exclusively in transmissions in accordance with the second communication standard.

8. The method of claim 6, further comprising reverting operation of the second-type wireless interface of the second-type apparatus to a default mode after expiry of a predetermined time after a control message has been received.

9. A second-type wireless apparatus or communication device comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses, wherein the non-volatile memory stores computer program instructions which, when executed by the one or more microprocessors configure the second-type wireless communication apparatus for performing the method of claim 6.

10. A method of operating a second-type base station of a network configured for wireless communication in accordance with a second communication standard, comprising:
if resource allocation information for a first-type apparatus within a given area covered by said second-type base station is not available from a corresponding first-type base station
receiving, from a third-type wireless apparatus in accordance with claim 5 and via a second-type wireless interface, a control message pertaining to selectively enabling or disabling an operation mode of second-type communication interfaces of second-type apparatus located in said given area, in which operation mode transmissions carrying information related to the reservation, allocation and/or use of shared resources that are transmitted in accordance with the first standard are received and/or decoded, and/or
receiving, from said third-type wireless apparatus, at least a relevant part of information pertaining to the use of a shared radio resource by the first-type wireless apparatus within the given area, and
transmitting, to second-type wireless apparatus located in said given area, a corresponding downlink control message.

11. The method of claim 10, wherein the downlink control message is transmitted as a broadcast V2X app message, a 5G NR DCI format message, or a system information message.

12. A second-type base station of a network configured for wireless communication in accordance with a second communication standard comprising:
one or more microprocessors, volatile memory, non-volatile memory, and
a second-type wireless interface for communicating with one or more third-type wireless apparatus or communication devices comprising at least one transmitting and/or receiving antenna and associated electronic radio frequency circuitry providing or implementing at least one first-type wireless interface and at least one second-type wireless interface, further comprising one or more microprocessors and associated volatile and non-volatile memory, wherein the aforementioned elements are communicatively connected via one or more signal or data connections or buses, and/or with one or more second-type wireless apparatus or communication devices comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses, and
further comprising a third-type communication interface for communicating with one or more network elements of a network configured for providing wireless communication in accordance with a first communication standard, wherein the aforementioned elements are communicatively connected via one or more signal or data connections or buses, wherein the non-volatile memory stores computer program instructions which, when executed by the one or more microprocessors, configure the second-type base station for performing the method of claim 10.

13. The method of claim 1, wherein the second communication standard comprises messages carrying sidelink control information that are transmitted via a physical control channel, including via a physical sidelink control channel, and wherein transmitting or receiving, respectively, a control message pertaining to selectively enabling or disabling an operation mode of the second-type communication interface of the second-type apparatus, in which operation mode transmissions carrying information related to the reservation, allocation and/or use of shared resources that are transmitted in accordance with the first standard are received and/or decoded, comprises transmitting or receiving said control message via a first-stage control information, including via a first-stage sidelink control information.

14. The method of claim 13, wherein the first-stage control information comprises information specifying a second-stage control information, including a second-stage sidelink control information, and wherein the second-stage control information is accessible or decodable after decoding the first-stage control information.

15. A non-transitory computer program product comprising instructions which, when the instructions are executed by a microprocessor, cause a computer and/or control hardware blocks, modules or components of a third-type wireless apparatus or communication device comprising at least one transmitting and/or receiving antenna and associated electronic radio frequency circuitry providing or implementing at least one first-type wireless interface and at least one second-type wireless interface, further comprising one or more microprocessors and associated volatile and non-volatile memory, wherein the aforementioned elements are communicatively connected via one or more signal or data connections or buses,
of a second-type wireless apparatus or communication device comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses,
or of a second-type base station comprising:
one or more microprocessors, volatile memory, non-volatile memory, and
a second-type wireless interface for communicating with one or more third-type wireless apparatus or communication devices comprising at least one transmitting and/or receiving antenna and associated electronic radio frequency circuitry providing or implementing at least one first-type wireless interface and at least one second-type wireless interface, further comprising one or more microprocessors and associated volatile and non-volatile memory, wherein the aforementioned elements are communicatively connected via one or more signal or data connections or buses, and/or with one or more second-type wireless apparatus or communication devices comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses, and
a third-type communication interface for communicating with one or more network elements of a network configured for providing wireless communication in accordance with a first communication standard, wherein the aforementioned elements are communicatively connected via one or more signal or data connections or buses, respectively, to carry out a method in accordance with claim 1.

16. A non-transitory computer readable medium or data carrier retrievably transmitting or storing the computer program product of claim 15.

17. The method of claim 6, wherein the second communication standard comprises messages carrying sidelink control information that are transmitted via a physical control channel, including via a physical sidelink control channel, and wherein transmitting or receiving, respectively, a control message pertaining to selectively enabling or disabling an operation mode of the second-type communication interface of the second-type apparatus, in which operation mode transmissions carrying information related to the reservation, allocation and/or use of shared resources that are transmitted in accordance with the first standard are received and/or decoded, comprises transmitting or receiving said control message via a first-stage control information, including via a first-stage sidelink control information.

18. The method of claim 10, wherein the second communication standard comprises messages carrying sidelink control information that are transmitted via a physical control channel, including via a physical sidelink control channel, and wherein transmitting or receiving, respectively, a control message pertaining to selectively enabling or disabling an operation mode of the second-type communication interface of the second-type apparatus, in which operation mode transmissions carrying information related to the reservation, allocation and/or use of shared resources that are transmitted in accordance with the first standard are received and/or decoded, comprises transmitting or receiving said control message via a first-stage control information, including via a first-stage sidelink control information.

19. A non-transitory computer program product comprising instructions which, when the instructions are executed by a microprocessor, cause a computer and/or control hardware blocks, modules or components of a third-type wireless apparatus or communication device comprising at least one transmitting and/or receiving antenna and associated electronic radio frequency circuitry providing or implementing at least one first-type wireless interface and at least one second-type wireless interface, further comprising one or more microprocessors and associated volatile and non-volatile memory, wherein the aforementioned elements are communicatively connected via one or more signal or data connections or buses,
of a second-type wireless apparatus or communication device comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses,
or of a second-type base station comprising:
one or more microprocessors, volatile memory, non-volatile memory, and
a second-type wireless interface for communicating with one or more third-type wireless apparatus or communication devices comprising at least one transmitting and/or receiving antenna and associated electronic radio frequency circuitry providing or implementing at least one first-type wireless interface and at least one second-type wireless interface, further comprising one or more microprocessors and associated volatile and non-volatile memory, wherein the aforementioned elements are communicatively connected via one or more signal or data connections or buses, and/or with one or more second-type wireless apparatus or communication devices comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses, and
a third-type communication interface for communicating with one or more network elements of a network configured for providing wireless communication in accordance with a first communication standard, wherein the aforementioned elements are communicatively connected via one or more signal or data connections or buses, respectively, to carry out a method in accordance with claim 6.

20. A non-transitory computer program product comprising instructions which, when the instructions are executed by a microprocessor, cause a computer and/or control hardware blocks, modules or components of a third-type wireless apparatus or communication device comprising at least one transmitting and/or receiving antenna and associated electronic radio frequency circuitry providing or implementing at least one first-type wireless interface and at least one second-type wireless interface, further comprising one or more microprocessors and associated volatile and non-volatile memory, wherein the aforementioned elements are communicatively connected via one or more signal or data connections or buses,
of a second-type wireless apparatus or communication device comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses,
or of a second-type base station comprising:
one or more microprocessors, volatile memory, non-volatile memory, and
a second-type wireless interface for communicating with one or more third-type wireless apparatus or communication devices comprising at least one transmitting and/or receiving antenna and associated electronic radio frequency circuitry providing or implementing at least one first-type wireless interface and at least one second-type wireless interface, further comprising one or more microprocessors and associated volatile and non-volatile memory, wherein the aforementioned elements are communicatively connected via one or more signal or data connections or buses, and/or with one or more second-type wireless apparatus or communication devices comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses, and
a third-type communication interface for communicating with one or more network elements of a network configured for providing wireless communication in accordance with a first communication standard, wherein the aforementioned elements are communicatively connected via one or more signal or data connections or buses, respectively, to carry out a method in accordance with claim 10.

21. A non-transitory computer program product comprising instructions which, when the instructions are executed by a microprocessor, cause a computer and/or control hardware blocks, modules or components of a third-type wireless apparatus or communication device comprising at least one transmitting and/or receiving antenna and associated electronic radio frequency circuitry providing or implementing at least one first-type wireless interface and at least one second-type wireless interface, further comprising one or more microprocessors and associated volatile and non-volatile memory, wherein the aforementioned elements are communicatively connected via one or more signal or data connections or buses,
of a second-type wireless apparatus or communication device comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses,
or of a second-type base station comprising:
one or more microprocessors, volatile memory, non-volatile memory, and
a second-type wireless interface for communicating with one or more third-type wireless apparatus or communication devices comprising at least one transmitting and/or receiving antenna and associated electronic radio frequency circuitry providing or implementing at least one first-type wireless interface and at least one second-type wireless interface, further comprising one or more microprocessors and associated volatile and non-volatile memory, wherein the aforementioned elements are communicatively connected via one or more signal or data connections or buses, and/or with one or more second-type wireless apparatus or communication devices comprising at least one transmitting and/or receiving antenna and associated electronic radio frequency circuitry, providing at least one second-type communication interface, further comprising one or more microprocessors and associated volatile and non-volatile memory, wherein the aforementioned elements are communicatively connected via one or more signal or data connections or buses, and
a third-type communication interface for communicating with one or more network elements of a network configured for providing wireless communication in accordance with a first communication standard, wherein the aforementioned elements are communicatively connected via one or more signal or data connections or buses, respectively, to carry out a method in accordance with claim 13.
